(19) United States
(12) Patent Application Publication
(10) Pub. No.: US 2025/0350695 A1
(43) Pub. Date: Nov. 13, 2025

(54) SHEET FEEDING APPARATUS AND IMAGE FORMING APPARATUS

(71) Applicant: CANON KABUSHIKI KAISHA, Tokyo (JP)

(72) Inventor: SHO OTA, Chiba (JP)

(21) Appl. No.: 19/175,425

(22) Filed: Apr. 10, 2025

(30) Foreign Application Priority Data
May 13, 2024 (JP) 2024-077915

(51) Int. Cl. H04N 1/00; G03G 15/00

(52) U.S. Cl. CPC H04N 1/00604; G03G 15/602; H04N 1/00615; H04N 1/00665; G03G 2215/00236

(57) ABSTRACT

A sheet feeding apparatus is disclosed that includes a sheet stacking portion, wherein with the extended sheet tray is attached to the sheet tray, the sheet stacking portion is configured to be switchable between in a first position in which the sheet stacking portion can stack the sheet and a second position that is closer to the apparatus main body than the first position, and wherein the sheet stacking portion is configured to be rotatable from the second position to the first position and not to be rotatable from the first position to the second position.

### BACKGROUND OF THE INVENTION

### Field of the Invention

This invention relates to a sheet feeding apparatus for feeding a sheet and an image forming apparatus such as a copying machine, a printer and a facsimile provided with the sheet feeding apparatus.

### Description of the Related Art

A conventional configuration is known in which an extended sheet tray is attached to a manual sheet feeding apparatus provided on a side wall of the apparatus main body of an image forming apparatus when a long sheet with the length of about 1000 mm to be used as a point-of-purchase display in a store should be printed (Japanese Patent Application Laid-Open No. 2021-53818). Such an extended sheet tray is provided with an attaching portion for being attached to the manual sheet feeding apparatus, and a sheet stacking portion for supporting an upstream side of a long sheet in the sheet feeding direction. Further, the sheet stacking portion is generally configured by a wire to reduce weight of the the extended sheet tray.

Furthermore, the sheet stacking portion of the extended sheet tray is required to be long enough to support a long sheet with the length of about 1000 mm. This leads to a bigger size of the extended sheet tray, further leading to a problem that a package box for packaging the extended sheet tray during its transportation becomes bigger. To deal with this problem, the configuration is known in which the sheet stacking portion is folded to the attaching portion so that the entire size of the extended sheet tray is reduced.

By the way, with the extended sheet tray becoming bigger, the passing of a user who walks near the side wall of the apparatus main body could be obstructed. Therefore, the extended sheet tray is required to be easily detached by a user when it is not used to make space for the passing of a user. The configuration in which the extended sheet tray can be easily detached is known as the one having a protruding portion urged by a spring provided at the attaching portion and a hole portion provided on the manual sheet feeding apparatus. In this configuration, when the attaching portion of the extended sheet tray is inserted into the hole portion of the manual sheet feeding apparatus, the protruding portion engages with the hole portion so that the extended sheet tray is fixed on the manual sheet feeding apparatus and the extended sheet tray is not detached if a predetermined force is not applied. This predetermined force is referred to as an engaging force Fm.

FIGS. 3 and 4A show the configuration of the conventional sheet feeding apparatus 50. FIG. 4A shows the state in which the tip portion of the wire 56 is in contact with the right side surface W of the apparatus main body. The arrow A in FIG. 4A shows the inserting direction of the extended sheet tray 51 to the manual sheet feeding apparatus 54.

The conventional sheet feeding apparatus 50 has the attaching portion 52, the sheet stacking portion 53 and the manual sheet feeding apparatus 54. The attaching portion 52 is attached to the manual feeding apparatus 54. The sheet stacking portion is provided with the wire 56 and can be rotated with respect to the attaching portion 52 around the shaft portion 59.

FIG. 3 shows the state in which the sheet stacking portion 53 is folded to the attaching portion 52. In this state, when a user passes by on the right side to the sheet feeding apparatus 50 in FIG. 3 and lifts up the extended sheet tray 51 along with the manual sheet feeding apparatus 54, the tip portion of the wire 56 becomes in contact with the right side surface W of the apparatus main body as shown in FIG. 4A.

When the extended sheet tray 51 is further lifted up in the counterclockwise direction from the state shown in FIG. 4A, the force F and the frictional force μF are applied to the tip of the wire 56 from the right side surface W of the apparatus main body where the reference character μ denotes a friction coefficient between the wire 56 and the right side surface W of the apparatus main body. The reference character 0 denotes the angle between the line connecting the shaft portion 59 and the contact point of the wire 56 that is in contact with the right side surface W of the apparatus main body, and the line perpendicular to the right side surface W. In this case, the sheet stacking portion 53 can be rotated with respect to the attaching portion 52 when the flowing expression (1) is satisfied.

$$F sin θ > μ F cos θ \qquad ( 1 )$$

Meanwhile, the sheet stacking portion 53 cannot be rotated with respect to attaching portion 52 when the expression (1) is not satisfied. Therefore, in this case, the extended sheet tray 51 cannot be rotated in the counterclockwise direction from the state shown in FIG. 4A. However, when a user further lifts up the extended sheet tray 51 in the counterclockwise direction from the state shown in FIG. 4A, the force F applied to the tip of the wire 56 from the right side surface W becomes larger and a force with which the extended sheet tray 51 is detached also becomes larger.

The reference character φ denotes the angle between the line connecting the shaft portion 59 and the tip of the wire 56 and the inserting direction A. In this case, the extended sheet tray 51 is detached from the manual sheet feeding apparatus 54 when the following expression (2) is satisfied.

$$F > Fm / ( cos θcos φ ) \qquad ( 2 )$$

When a user further applies a force after the extended sheet tray 51 is detached from the manual sheet feeding apparatus 54, a problem may occur that the extended sheet tray is detached from the manual sheet feeding apparatus 54 so that the extended sheet tray 51 is damaged after it collides with the ground surface. In order to avoid this problem, it is preferrable that the expression (1) is always satisfied.

The expression (3) is obtained by transforming the expression (1).

$$tan θ > μ \qquad ( 3 )$$

This shows that the expression (3) is satisfied when the angle θ becomes larger. Therefore, by increasing the angle θ, the sheet stacking portion 53 can be rotated even if the wire 56 becomes in contact with the right side surface W of the apparatus main body. Further, the extended sheet tray 51 is hard to be detached by increasing the angle θ. The configurations for increasing the angle θ include the one with an angle restricting portion that prohibits the sheet stacking portion 53 from rotating more than a predetermined angle with respect to the attaching portion 52 in the direction in which the sheet stacking portion 53 approaches the right side surface W (counterclockwise direction in FIG. 3).

However, in the configuration in which the angle restricting portion is provided in the sheet feeding apparatus, there is a problem that the size of the package for the extended sheet tray may be larger since the rotation amount of the sheet stacking portion with respect to the attaching portion is restricted.

### SUMMARY OF THE INVENTION

An object of the invention is to provide a sheet feeding apparatus and an image forming apparatus that can prevent the extended sheet tray from being detached from the sheet tray and can reduce the package size of the extended sheet tray.

A sheet feeding apparatus for feeding a sheet according to the present invention, comprising:

a sheet tray provided on a side wall portion of an apparatus main body of the sheet feeding apparatus, the sheet tray being configured to stack the sheet; and

an extended sheet tray attached to an upstream side of the sheet tray in a feeding direction the sheet, the extended sheet tray being configured to stack the sheet,

wherein the extended sheet tray is provided with a sheet tray attaching portion detachably attached to the sheet tray, and a sheet stacking portion rotatably attached to the sheet tray attaching portion, the sheet stacking portion being configured to stack the sheet,

wherein with the extended sheet tray is attached to the sheet tray, the sheet stacking portion is configured to be switchable between a first position in which the sheet stacking portion can stack the sheet and a second position that is closer to the apparatus main body than the first position, and

wherein the sheet stacking portion is configured to be rotatable from the second position to the first position and not to be rotatable from the first position to the second position.

Further features of the present invention will become apparent from the following description of exemplary embodiments with reference to the attached drawings.

### BRIEF DESCRIPTION OF THE DRAWINGS

FIG. 1 is a schematic diagram of an image forming apparatus according to an embodiment of the present invention.

FIG. 2 is a diagram showing a front view of a sheet conveying apparatus according to the embodiment of the present invention.

FIG. 3 is a diagram showing a front view of a conventional sheet feeding apparatus.

FIGS. 4A and 4B are diagrams showing front views of the sheet feeding apparatus according to the embodiment of the present invention as compared with the conventional sheet feeding apparatus.

FIG. 5 is a diagram showing a top view of a part of the sheet feeding apparatus according to the embodiment of the present invention.

FIGS. 6A and 6B are diagrams respectively showing a front view and a cross-sectional view of a part of the sheet feeding apparatus according to the embodiment of the present invention during sheet-passing operation.

FIGS. 7A and 7B are diagrams showing perspective views of a part of the sheet feeding apparatus according to the embodiment of the present invention.

FIGS. 8A and 8B are diagrams respectively showing a front view and a cross-sectional view of a part of the sheet feeding apparatus according to the embodiment of the present invention in a posture when packaged.

FIGS. 9A and 9B are diagrams respectively showing a front view and a cross-sectional view of a part of the sheet feeding apparatus according to the embodiment of the present invention in a posture on a way from the posture in the state in which the sheet feeding apparatus is packaged to the posture in the state in which the sheet feeding apparatus is in the sheet-passing operation.

FIGS. 10A and 10B are diagrams respectively showing a front view and a cross-sectional view of a part of the sheet feeding apparatus according to the embodiment of the present invention in a posture on a way from the posture in the state in which the sheet feeding apparatus is in the sheet-passing operation to the posture in the state in which the sheet feeding apparatus is packaged.

### DESCRIPTION OF THE EMBODIMENTS

In the following, embodiments of the present invention will be described with reference to the figures.

### <Configuration of Image Forming Apparatus>

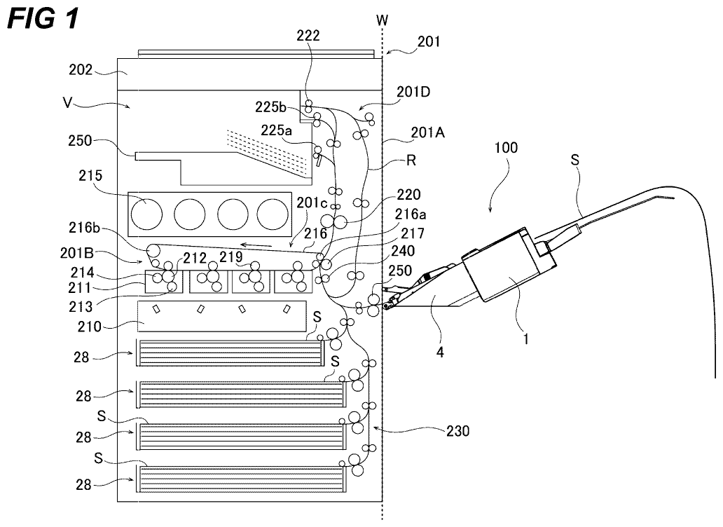

The configuration of the image forming apparatus 201 according to the embodiment of the present invention will be described in detail with reference to FIG. 1.

The image forming apparatus 201 has the sheet feeding apparatus 100, the apparatus main body 201A, the image forming portion 201B, the double-sided document reversing portion 201D, the image reading portion 202, the first discharge roller pair 225a, the second discharge roller pair 225b, the stacking portion 223, the feeding portion 230, the registration roller 240, and the conveying roller 250. In the image forming apparatus 201, the discharge space V for discharging the sheet S is formed between the image reading apparatus 202 and the apparatus main body 201A in the image forming apparatus 201.

The sheet feeding apparatus 100 is provided on the side wall portion of the apparatus main body 201A and feeds the sheet S toward the registration roller 240. The details of the sheet feeding apparatus 100 will be described later.

The apparatus main body 201A is provided under the image reading apparatus 202 and accommodates the image forming portion 201B and so on.

The image forming portion 201B forms an image of four colors of yellow (Y), magenta (M), cyan (C) and black (K) on the sheet S fed by the feeding portion 230. Specifically, the image forming portion 201B is provided with the intermediate transfer unit 201C, the laser scanner 210, the process cartridge 211, the photosensitive drum 212, the charging device 213, the developing device 214, the toner cartridge 215, the secondary transfer roller 217, the primary transfer roller 219, and the fixing portion 220.

The intermediate transfer unit 201C is provided above the process cartridges 211. Specifically, the intermediate transfer unit 201C is provided with the intermediate transfer belt 216, the driving roller 216a, and the tension roller 216b.

The intermediate transfer belt 216 is wound around the driving roller 216a and the tension roller 216b. The intermediate transfer belt 216 rotates by being driven by the driving roller 216a in the direction of arrow in FIG. 1.

The driving roller 216a stretches the intermediate transfer belt 216 along with the tension roller 216b. The driving roller 216a is driven by a driving portion (not shown).

The tension roller 216b stretches the intermediate transfer belt 216 along with the driving roller 216a.

The surface of the photosensitive drum 212 is uniformly charged at a predetermined polarity and potential by the charging device 213. The laser scanner 210 irradiates the surface of the photosensitive drum 212 with a laser beam based on an electrical signal transmitted from the image reading apparatus 202 to sequentially expose the surface of the photosensitive drum 212. As a result, electrostatic latent images of yellow, magenta, cyan and black are sequentially formed on the photosensitive drum 212.

Four process cartridges 211 are provided corresponding to the four colors of yellow (Y), magenta (M), cyan (C) and black (K). The process cartridges 211 forms toner images of the four colors respectively.

Electrostatic images for yellow, magenta, cyan and black are sequentially formed on the photosensitive drums 212.

The charging device 213 uniformly charges the surface of the photosensitive drum 212 at a predetermined polarity and potential.

The developing device 214 develops an electrostatic latent image for each color formed on each photosensitive drum 212 with toner for each color to visualize the electrostatic latent image.

The toner cartridge 215 supplies the developing device 214 with toner.

The secondary transfer roller 217 is provided at a position opposed to the driving roller 216a. By the second transfer bias being applied to the secondary transfer roller 217, the secondary transfer roller 217 transfers the color toner image that has been transferred onto the intermediate transfer belt 216 onto the sheet S fed by the feeding portion 230 in a batch. The secondary transfer roller 217 conveys to the fixing portion 220 the sheet S on which the color toner image has been transferred.

The primary transfer roller 219 is provided in the position opposed to the photosensitive drum 212 inside the intermediate transfer belt 216. The primary transfer roller 219 is in contact with the intermediate transfer belt 216. By the primary transfer bias being applied to the primary transfer roller 219, the primary transfer roller 219 transfers each toner image with negative polarity on each photosensitive drum 212 onto the intermediate transfer belt 216 in a sequentially superimposing manner.

The fixing portion 220 is provided above the secondary transfer roller 217. The fixing portion 220 applies heat and pressure to the sheet S conveyed by the secondary transfer roller 217 to melt and mix the toner of the toner images for respective colors transferred on the sheet S so that toner images for respective colors are fixed as a color image on the sheet S. The fixing portion 220 conveys the sheet S on which the color image has been fixed to the first discharge roller pair 225a or the second discharge roller pair 225b.

The double-sided document reversing portion 201D is provided above the fixing portion 220. The double-sided document reversing portion 201D is provided with the reverse roller pair 222.

The image reading apparatus 202 reads image information of a document. The image reading apparatus 202 image-processes the read image information, converts the image-processed image information into an electrical signal, and transmits it to the laser scanner 210 of the image forming portion 201B.

The first discharge roller pair 225a is provided above and downstream of the fixing portion 220 in the conveying direction of the sheet S. The first discharge roller pair 225a discharges the sheet S conveyed by the fixing portion 220 to the discharge space V.

The second discharge roller pair 225b is provided above and downstream of the fixing portion 220 in the conveying direction of the sheet S. The second discharge roller pair 225b discharges the sheet S conveyed by the fixing portion 220 to the discharge space V.

The stacking portion 223 is provided protruding into the discharge space V. The sheets S discharged by the first discharge roller pair 225a or the second discharge roller pair 225b are stacked on the stacking portion 223.

The reverse roller pair 222 can rotate normally and reversely and conveys the sheet S which has been conveyed by the fixing portion 220 and on which an image has been formed to the re-conveying path R in order to covey the sheet S to the image forming portion 201B again.

The feeding portion 230 is provided at a lower portion of the apparatus main body 201A. The feeding portion 230 accommodates the sheets S and feeds the accommodated sheets S to the image forming portion 201B.

The registration roller 240 adjusts the skew feeding of the sheet S fed by the feeding portion 230 or the manual feeding apparatus 19 and conveys the sheet S whose skew feeding has been adjusted to the secondary transfer roller 217.

The conveying roller 250 conveys the sheet S fed by the manual feeding apparatus 19 to the registration roller 240.

The sheet feeding apparatus 100 of the image forming apparatus 201 with the above described configuration has a pair of downstream side restricting plates (not shown) that restrict both end portions of the sheet S in the direction perpendicular to the conveying direction of the sheet S. Further, a rack (not shown) is provided on the underside of the pair of downstream side restricting plates. When one of the pair of downstream side restricting plates is moved, the other of the pair of downstream side restricting plates can be moved by a pinion (not shown) meshing with the rack.

The sheets S stacked on the sheet feeding apparatus 100 are fed by a roller (not shown) that is in contact with the upper surface of the sheets S and are separated one by one at the nip formed by the feed roller and the retard roller (not shown) to separately feed each of the sheets S to the conveying roller 250.

### <Configuration of Sheet Feeding Apparatus>

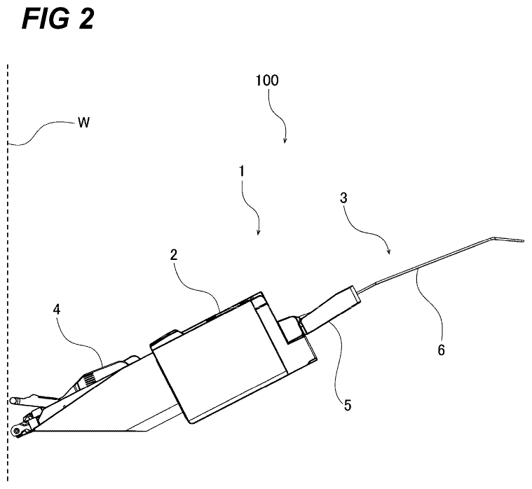

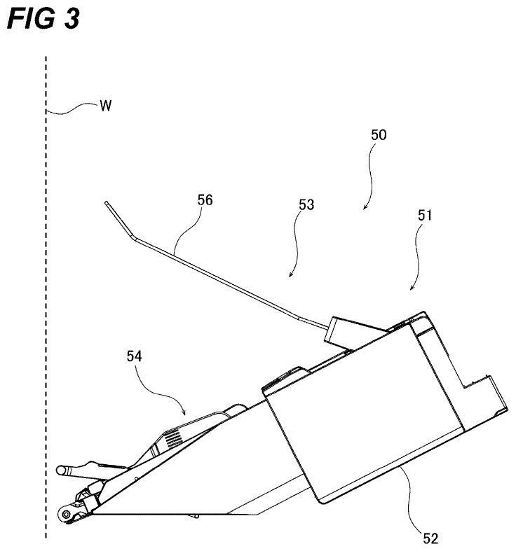

The configuration of the sheet feeding apparatus 100 according to the embodiment of the present invention will be described with reference to FIGS. 2 to 5 and 7.

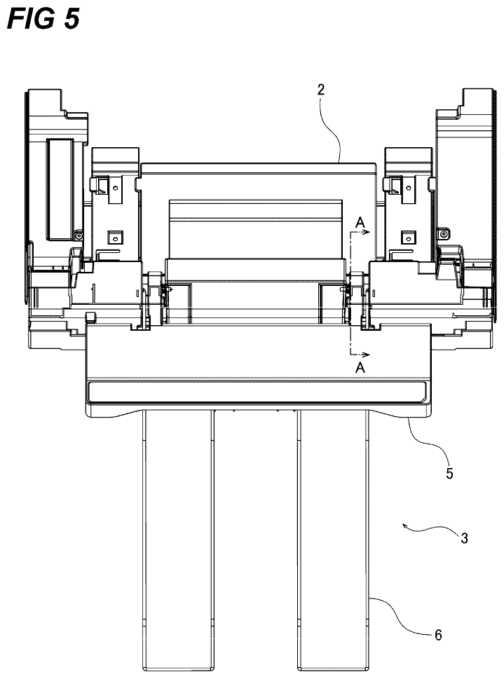

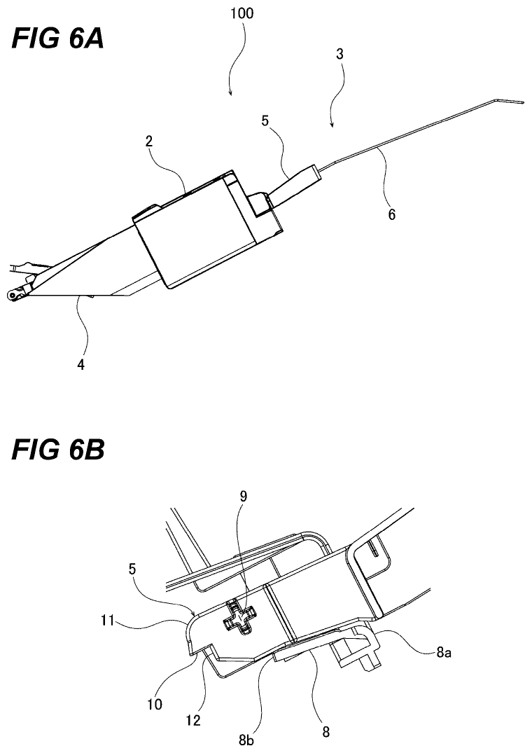

FIG. 6A is a diagram showing a front view of the entirety of sheet feeding apparatus 100 in the posture for the sheet-passing. FIG. 6B is a diagram showing an A-A cross-sectional view in FIG. 5 of the sheet feeding apparatus 100 in the posture for the sheet-passing.

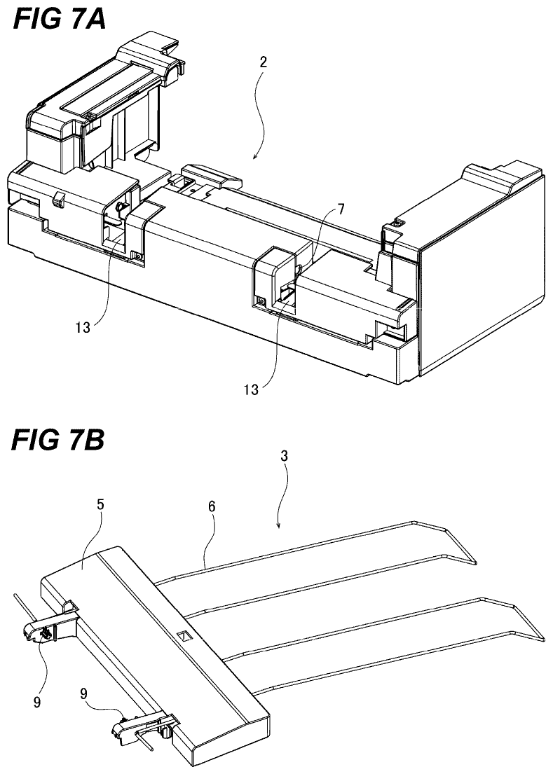

FIG. 7A is a diagram showing a perspective view of the sheet tray attaching portion 2 and the FIG. 7B is a diagram showing a perspective view of the sheet stacking portion 3.

The sheet feeding apparatus 100 has the extended sheet tray 1 and the sheet tray 4.

The extended sheet tray 1 is attached at the upstream side of the sheet tray 4 in the feeding direction of the sheet S.

The sheet tray attaching portion 2 is made from resin and detachably attached to the sheet tray 4. The sheet tray attaching portion 2 is provided with the rotation center portion 7, the claw portion 8 and the holding portion 13.

The shaft portion 9 (described later) of the sheet stacking portion 3 rotatably engages with the rotation center portion 7.

The claw portion 8 as an elastic portion is cantilevered and has the proximal end portion 8a and the distal end portion 8b.

The proximal end portion 8a is attached to the sheet tray attaching portion 2.

The distal end portion 8b is elastically deformable. When the guide portion 5 rotates, the distal end portion 8b becomes slidably in contact with the inclined surface portion 11 (described later) of the guide portion 5 and when the distal end portion 8b is in contact with the restriction portion 12, the distal end portion 8b restricts the rotation of the sheet stacking portion 3 when the distal end portion 8b is in contact with the restriction portion 12.

The holding portion 13 holds the sheet stacking portion 3 in the posture for the sheet-passing by being in contact with the wire portion 6 of the sheet stacking portion 3. The sheet-passing means feeding of the sheet S by the sheet feeding apparatus 100.

The long sheets S can be stacked on the sheet stacking portion 3. In the state where the extended sheet tray 1 is attached to the sheet tray 4, the sheet stacking portion 3 can take a first position in which the sheets S can be stacked and a second position which is closer to the apparatus main body 201A than the first position by switching. The sheet stacking portion 3 is configured to be able to rotate from the second position to the first position but not to be able to rotate from the first position to the second position. Specifically, the sheet stacking portion 3 is provided with the guide portion 5 and the wire portion 6.

The guide portion 5 is made of resin and guides the feeding of sheets S. The guide portion 5 is provided with the shaft portion 9, the engaging portion 10, the inclined surface portion 11 and the restricting portion 12.

The shaft portion 9 is of a rotation center around which the sheet stacking portion 3 rotates with respect to the sheet tray attaching portion 2. The shaft portion 9 rotatably engages with the rotation center portion 7.

The engaging portion 10 can be in contact with the distal end portion 8b of the claw portion 8.

The inclined surface portion 11 is provided in the vicinity of the engaging portion 10. The inclined surface portion 11 is curved along the direction of the rotation of the sheet stacking portion 3 such that the distance between the shaft portion 9 and the inclined surface portion 11 becomes gradually larger towards the engaging portion 10.

The restricting portion 12 is provided adjacent to the the engaging portion 10 and is able to be in contact with the distal end portion 8b of the claw portion 8.

The wire portion 6 is made from metal and attached to the guide portion 5. The wire portion 6 holds the sheet stacking portion 3 in the first position in which the sheets S can be stacked by the wire portion 6 being in contact with the holding portion 13.

The sheet tray 4 is provided on the side wall portion of the apparatus main body 201A and configured to be able to stack the sheets S. The sheets S stacked on the sheet tray 4 are fed to the image forming portion 201B by the conveying roller 250 and the registration roller 240.

### <Operation of Sheet Feeding Apparatus>

The operation of the sheet feeding apparatus 100 according to the embodiment of the present invention will be described in detail with reference to FIGS. 2, and 4B to 10.

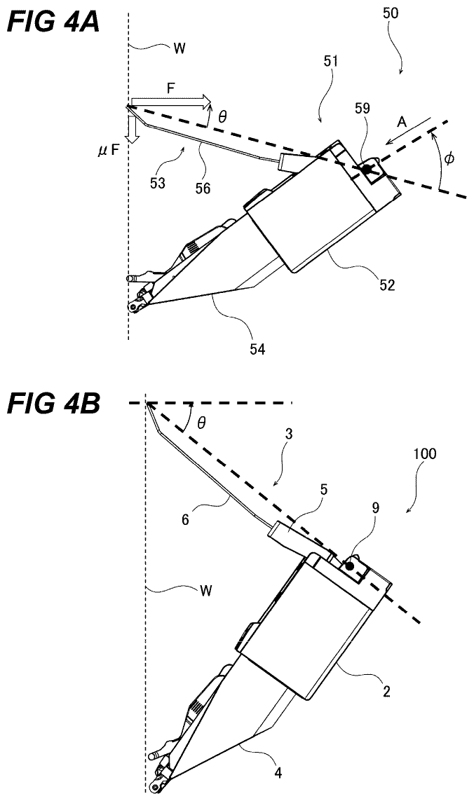

FIG. 4B shows the state where the sheet stacking portion 3 cannot rotate more than a predetermined angle with respect to the sheet tray attaching portion 2.

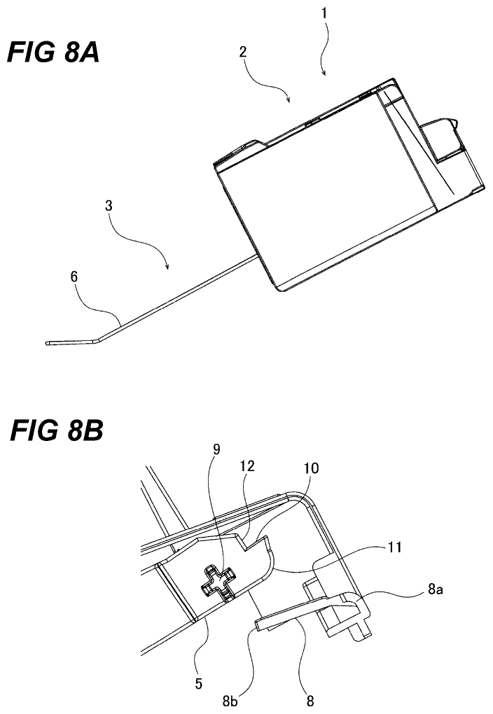

FIG. 8A is a diagram showing a front view of the entirety of the extended sheet tray 1 in the posture for packaging. FIG. 8B is a diagram showing an A-A cross-sectional view of the extended sheet tray 1 in FIG. 5 in the posture for packaging.

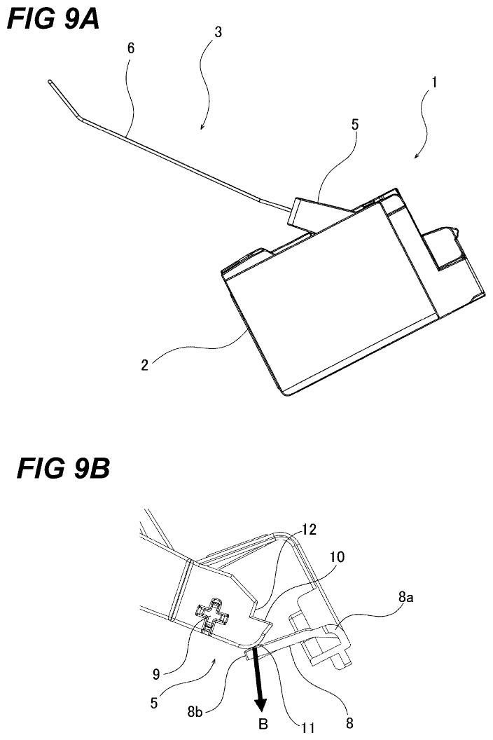

FIG. 9A is a diagram showing a front view of the extended sheet tray 1 during rotation on a way from the posture for packaging to the posture for sheet-passing. FIG. 9B is a diagram showing an A-A cross-sectional view of the extended sheet tray 1 in FIG. 5 during rotation on a way from the posture for packaging to the posture for sheet-passing.

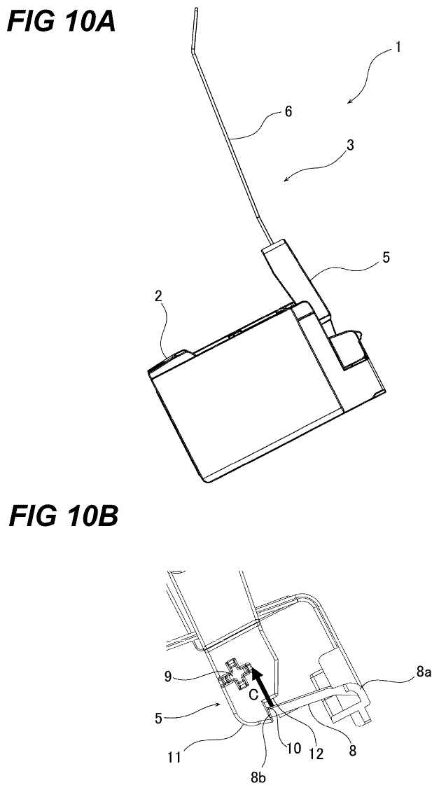

FIG. 10A is a diagram showing a front view of the entirety of the extended sheet tray 1 during rotation on a way from the posture for sheet-passing to the posture for packaging. FIG. 10B is a diagram showing an A-A cross-sectional view of the extended sheet tray 1 in FIG. 5 during rotation on a way from the posture for sheet-passing to the posture for packaging.

First, the operation of the sheet feeding apparatus 100 in the case where the extended sheet tray 1 is moved from the posture for packaging in which the sheet stacking portion 3 is located in the second position to the posture for sheet-passing in which the sheet stacking portion 3 is located in the first position will be described in detail.

The extended sheet tray 1 in the state shown in FIG. 8A when the extended sheet tray 1 is packaged. In this case, the sheet stacking portion 3 is located in the second position and the guide portion 5 and the claw portion 8 are separated from each other as shown in FIG. 8B.

After the extended sheet tray 1 is unpackaged, the sheet stacking portion 3 is rotated in the clockwise direction in FIG. 8A in order to change the posture of the extended sheet tray 1 for packaging shown in FIGS. 8A and 8B to the posture for sheet-passing.

When the sheet stacking portion 3 is started to rotate from the state shown in FIG. 8A, the inclined surface portion 11 of the guide portion 5 becomes in contact with and rides on the distal end portion 8b of the claw portion 8.

By further rotating the sheet stacking portion 3 in the clockwise direction in FIG. 9A with the inclined surface portion 11 having ridden on the distal end portion 8b, the inclined surface portion 11 presses the distal end portion 8b in the direction of arrow B in FIG. 9B, so that the distal end portion 8b is elastically deformed around the proximal end portion 8a in the direction of arrow B.

By further rotating the sheet stacking portion 3 in the clockwise direction in FIG. 9B with the inclined surface portion 11 pressing the distal end portion 8b in the direction of arrow B, the inclined surface portion 11 passes through the distal end portion 8b, so that the pressing of the inclined surface portion 11 on the distal end portion 8b is released as shown in FIG. 6B. As a result, the claw portion 8 returns to the initial state by its own elastic returning force.

By further rotating the sheet stacking portion 3 in the clockwise direction in FIG. 9B with the inclined surface portion 11 having passed through the distal end portion 8b, the wire portion 6 becomes in contact with the holding portion 13, so that the sheet feeding apparatus 100 takes the posture for sheet-passing. As a result, the sheet stacking portion 3 rotates from the second position to the first position.

Next, the operation of the sheet feeding apparatus 100 in the case where the extended sheet tray 1 is moved from the posture for sheet-passing in which the sheet stacking portion 3 is located in the first position to the posture for packaging in which the sheet stacking portion 3 is located in the second position will be described in detail.

By rotating the sheet stacking portion 3 in the posture for sheet-passing shown in FIG. 6A in the counterclockwise direction, the engaging portion 10 engages with the distal end portion 8b of the claw portion 8 as shown in FIG. 10B.

By further rotating the sheet stacking portion 3 in the counterclockwise direction in FIG. 10A with the engaging portion 10 being engaged with the distal end portion 8b, the distal end portion 8b is elastically deformed around the proximal portion 8a in the direction of arrow C in FIG. 10B to become in contact with the restricting portion 12.

When the sheet stacking portion 3 is pressed in the direction in which the sheet stacking portion 3 is further rotated in the counterclockwise direction in FIG. 10B with the distal end portion 8b being in contact with the restricting portion 12, the sheet stacking portion 3 cannot be rotated any more in the counterclockwise direction. As a result, the sheet stacking portion 3 cannot rotate from the first direction to the second direction.

As described above, the sheet stacking portion 3 can rotate from the second position to the first position, whereas the sheet stacking portion 3 cannot rotate from the first position to the second position. With this configuration, as shown in FIG. 4B, the angle θ between the line connecting the shaft portion 9 and the contact point of the wire 6 that is in contact with the right side surface W as a side wall portion of the apparatus main body 201A, and the line perpendicular to the right side surface W can be larger than the conventional one.

In the embodiment of the present invention, the extended sheet tray 1 is provided that has the sheet tray attaching portion 2 detachably attached to the sheet tray 4, and the sheet stacking portion 3 that is rotatably attached to the sheet tray attaching portion 2 and on which the sheet S can be stacked. In the embodiment of the present invention, the sheet stacking portion 3 can be switched to the first position in which the sheet S can be stacked with the extended sheet tray 1 being attached to the sheet tray 4, and to the second position that is closer to the apparatus main body 201A than the first position. The sheet stacking portion 3 is configured to be able to rotate from the second position to the first position and to unable to rotate from the first position to the second position.

With this configuration, the size of the extended sheet tray 1 when it is packaged can be reduced and the falling out of the extended sheet tray 1 from the sheet tray 4 can be avoided.

The present invention is not limited to the above embodiment and can be variously modified without departing from the gist of the invention.

Specifically, although the angle θ is made larger when the wire portion 6 is in contact with the right side surface W of the apparatus main body 201A in the above embodiment, however the configuration is not limited this one and the angle θ can be made larger when the wire portion 6 enters a step of the exterior cover of the apparatus main body 201A. In this case, when the wire portion 6 enters the step of the exterior cover of the apparatus main body 201A, it can be suppressed for a force to be applied on the extended sheet tray 1 in the direction in which it falls down.

Further, in the above embodiment, by the wire portion 6 becoming in contact with the apparatus main body 201A, the rotation of the sheet stacking portion 3 to the the second position is restricted. However, the configuration is limited to this one and the rotation of the sheet stacking portion 3 to the second position can be restricted by the wire portion 6 becoming in contact with the apparatus main body of the sheet feeding apparatus 100.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-77915, filed May 13, 2024, which is hereby incorporated by reference herein in its entirety.

What is claimed is:

1. A sheet feeding apparatus for feeding a sheet, comprising:
a sheet tray provided on a side wall portion of an apparatus main body of the sheet feeding apparatus, the sheet tray being configured to stack the sheet; and
an extended sheet tray attached to an upstream side of the sheet tray in a feeding direction the sheet, the extended sheet tray being configured to stack the sheet,
wherein the extended sheet tray is provided with a sheet tray attaching portion detachably attached to the sheet tray, and a sheet stacking portion rotatably attached to the sheet tray attaching portion, the sheet stacking portion being configured to stack the sheet,
wherein with the extended sheet tray is attached to the sheet tray, the sheet stacking portion is configured to be switchable between a first position in which the sheet stacking portion can stack the sheet and a second position that is closer to the apparatus main body than the first position, and
wherein the sheet stacking portion is configured to be rotatable from the second position to the first position and not to be rotatable from the first position to the second position.

2. The sheet feeding apparatus according to claim 1,
wherein the sheet stacking portion includes a guide portion made from resin and a wire portion made from metal that is provided on the guide portion.

3. The sheet feeding apparatus according to claim 2,
wherein the sheet tray attaching portion is provided with an elastic portion that becomes in contact with the guide portion when the sheet stacking portion is rotated, and
wherein the sheet stacking portion is rotated to the first position by the elastic portion that becomes in contact with the guide portion being elastically deformed when the sheet stacking portion is rotated from the second position toward the first position.

4. The sheet feeding apparatus according to claim 2,
wherein the sheet tray attaching portion is provided with an elastic portion that is elastically deformed by becoming in contact with the guide portion when the guide portion is rotated, and
wherein the sheet stacking portion is restricted from rotating to the second position by the elastic portion that is in contact with the guide portion being not elastically deformed when the sheet stacking portion is rotated from the first position toward the second position.

5. An image forming apparatus comprising:
a sheet feeding apparatus according to claim 1; and
an image forming portion configured to form an image on the sheet fed by the sheet feeding apparatus.
